(19) United States
(12) Patent Application Publication
(10) Pub. No.: US 2010/0220905 A1
(43) Pub. Date: Sep. 2, 2010

(54) IMAGE DIAGNOSIS SUPPORT APPARATUS, RIGHT AND LEFT BREAST IMAGE POSITION CORRESPONDING METHOD AND PROGRAM

(76) Inventor: Shinsuke Katsuhara, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/681,002

(22) PCT Filed: Sep. 26, 2008
(86) PCT No.: PCT/JP2008/067437

§ 371 Date: Mar. 31, 2010

(30) Foreign Application Priority Data
Oct. 1, 2007 (JP) 2007-257652

(51) Int. Cl. G06K 9/00

(52) U.S. Cl. 382/128

(57) ABSTRACT

It is an object to make diagnostically corresponding positions in a pair of left and right breast images accurately correspond to each other. An image diagnosis support apparatus detects positions of nipples from a pair of left and right breast images, calculates a straight line l to show inclinations of the breasts based on the detected nipples, sets up a polar coordinate system with its origin at the position of the nipple and its axis on the straight line l in each of the left and right breast images, and makes the positions in the left and right breast images correspond to each other in the polar coordinate systems.

### TECHNICAL FIELD

The present invention relates to an image diagnosis support apparatus, left and right breast image position corresponding method and program.

### BACKGROUND ART

Conventionally, a breast image obtained by radiographic imaging of breasts is displayed on a display apparatus such as a CRT (Cathode Ray Tube), LCD (Liquid Crystal Display), etc. or printed on film and then presented to a doctor for diagnosis by interpretation of the radiographic image. When a doctor diagnoses a breast image, the doctor performs the so-called comparison interpretation where a pair of left and right breast images are displayed side-by-side to be compared. Diagnosis is performed by comparing the left and right breasts because the normal form of the left and right breasts are substantially the same. For example, when a shadow suspected to be an abnormality is found in either one of the left or right breast images, the shadow can be determined to be an abnormal shadow or not depending on whether or not a similar shadow exists in a corresponding position in the other breast image.

In order to allow a doctor to perform comparison interpretation easily, various techniques to match the position of the pair of left and right breast images to be compared have been proposed. For example, Patent Document 1 describes a technique where a nipple is to be a reference point and two points of edges of the breasts are to be corresponding points and deforming a breast image so that the reference point and the corresponding points of one breast image match the reference point and the corresponding points of the other breast image.

### Patent Document 1: Japanese Patent Application Laid-Open Publication No. 2006-102091

### DISCLOSURE OF THE INVENTION

### Problems to be Solved by the Invention

However, since the breasts are compressed when the breasts are imaged, difference between the right and the left occurs due to the difference of strength or direction of compression of the left and right breasts, etc., and the edge of the breast in the left and right breast images may not be the same diagnostic corresponding tissue. Therefore, with the technique described in Patent Document 1, position of the left and right breast images are matched by appearance, however it was difficult to accurately correspond the positions with the same tissue in the left and right breast images, in other words, the diagnostic corresponding positions.

An object of the present invention is to accurately make the corresponding diagnostic positions of a pair of left and right breast images correspond to each other.

### Means for Solving the Problem

In order to achieve the above object, according to a first aspect of the present invention, there is provided an image diagnosis support apparatus including:

a nipple position detection section to detect a position of a nipple from each of a pair of left and right breast images;

a breast inclination calculation section to calculate a straight line to show inclination of a breast based on the position of the nipple detected from each of the left and right breast images; and

a left and right breast position corresponding section to set a polar coordinate system with an origin at the detected position of the nipple and an axis on the straight line which shows the calculated inclination of the breast in each of the left and right breast images and to make positions in the left and right breast images correspond to each other in the polar coordinate systems.

Preferably, the image diagnosis support apparatus further includes an image output section to perform output by adding a scale to show an angle from the axis and a distance from the origin in each of the left and right breast images.

Preferably, the image diagnosis support apparatus further includes:

a display section to display the left and right breast images;

an operation section to specify a desired position in either one of the left and right breast images displayed on the display section; and

an annotation display section to display an annotation in a position in the other breast image in which an angle from the axis and a distance from the origin matches those of the position specified with the operation section in the one of the breast images.

According to a second aspect of the present invention, there is provided a method to make positions correspond in left and right breast images, the method including:

detecting a position of a nipple from each of a pair of left and right breast images;

calculating a straight line to show inclination of a breast based on the position of the nipple detected from each of the left and right breast images; and

setting a polar coordinate system with an origin at the detected position of the nipple and an axis on the straight line which shows the calculated inclination of the breast in each of the left and right breast images and making positions in the left and right breast images correspond to each other in the polar coordinate systems.

Preferably, the method to make positions correspond in left and right breast images further includes performing output by adding a scale to show an angle from the axis and a distance from the origin in each of the left and right breast images.

Preferably, the method to make positions correspond in left and right breast images further includes:

displaying the left and right breast images;

specifying with an operation section a desired position in either one of the left and right breast images displayed on the display section; and

displaying an annotation in a position in the other breast image in which an angle from the axis and a distance from the origin matches those of the position specified in the one of the breast images.

According to a third aspect of the present invention, there is provided a program to allow a computer to function as:

a nipple position detection section to detect a position of a nipple from each of a pair of left and right breast images;

a breast inclination calculation section to calculate a straight line to show inclination of a breast based on the position of the nipple detected from each of the left and right breast images; and

a left and right breast position corresponding section to set a polar coordinate system with an origin at the detected position of the nipple and an axis on the straight line which shows the calculated inclination of the breast in each of the left and right breast images and to make positions in the left and right breast images correspond to each other in the polar coordinate systems.

Preferably, the program allows a computer to further function as an image output section to perform output by adding a scale to show an angle from the axis and a distance from the origin in each of the left and right breast images.

Preferably, the program allows a computer to further function as:

a display section to display the left and right breast images;

an operation section to specify a desired position in either one of the left and right breast images displayed on the display section; and

an annotation display section to display an annotation in a position in the other breast image in which an angle from the axis and a distance from the origin matches those of the position specified with the operation section in the one of the breast images.

### ADVANTAGEOUS EFFECT OF THE INVENTION

According to the present invention, a polar coordinate system is set in each of the pair of left and right breast images with its origin at the nipple and its axis on the straight line showing the inclination of the breast and makes the positions in the left and right breast images correspond to each other in the polar coordinate systems, and consequently, the diagnostic corresponding positions in the pair of left and right breast images can be made to correspond to each other accurately.

Also, a scale showing an angle from the axis of the polar coordinate system and a distance from the origin of the polar coordinate system is added to each of the pair of left and right breast images when the images are output, and consequently a doctor can easily recognize the diagnostic corresponding positions in the left and right breast images and accuracy of the comparison interpretation can be enhanced. Also, diagnostic efficiency can also be enhanced.

Also, an annotation is displayed in a position in the other breast image corresponding to a position specified in either one of the pair of left and right breast images, and consequently, the doctor can easily recognize the diagnostic corresponding positions in the left and right breast images and accuracy of the comparison interpretation can be enhanced. Also, diagnostic efficiency can also be enhanced.

### BRIEF DESCRIPTION OF THE DRAWINGS

FIG. 1 is a block diagram showing a functional configuration of an image diagnosis support apparatus according to an embodiment of the present invention;

FIG. 2 is a flowchart showing a left and right breast mapping processing performed by a CPU shown in FIG. 1;

FIG. 3 is a flowchart showing a nipple position detection processing shown in FIG. 2;

FIG. 4 is a diagram describing a coordinate of breast image data;

FIG. 5 is a diagram describing step S103 shown in FIG. 3;

FIG. 6 is a flowchart showing a breast inclination calculation processing shown in FIG. 2;

FIG. 7 is a diagram describing a calculation method of straight line l showing an inclination of the breast;

FIG. 8 is a flowchart showing a left and right breast position corresponding processing shown in FIG. 2;

FIG. 9 is a flowchart showing an image output processing shown in FIG. 2;

FIG. 10 is a diagram schematically showing an example of left and right breast images displayed on a display section shown in FIG. 1; and

FIG. 11 is a flowchart showing an annotation display processing according to a second embodiment of the present invention.

### BEST MODE FOR CARRYING OUT THE INVENTION

Below, first and second embodiments of the present invention will be described. The present embodiment is not limited to the illustrated examples.

### First Embodiment

First, a configuration of the first embodiment will be described.

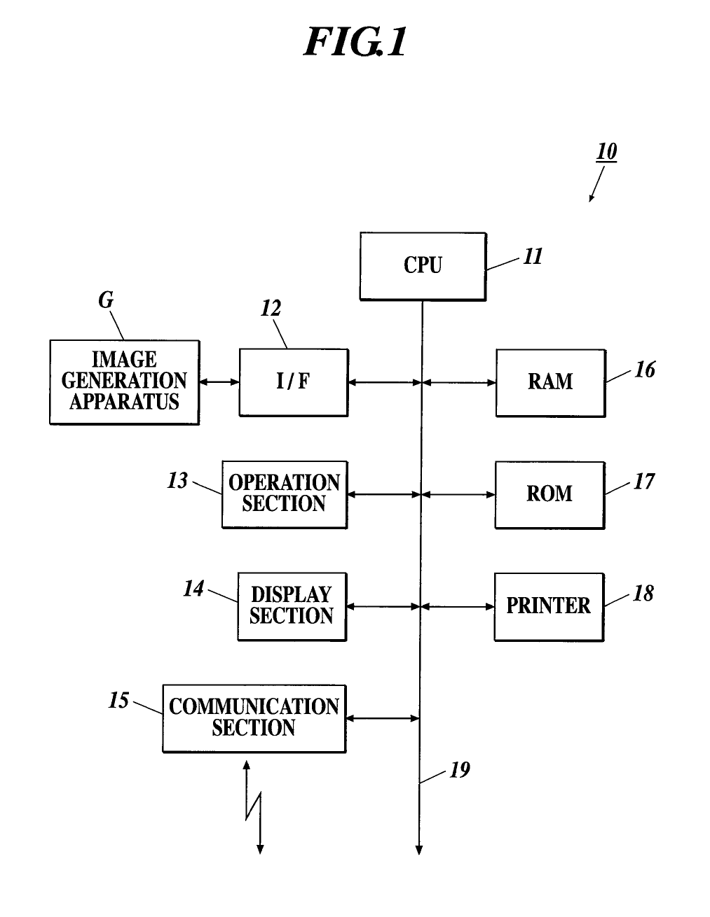

FIG. 1 shows an example of a functional configuration of an image diagnosis support apparatus 10 of the present embodiment.

As shown in FIG. 1, the image diagnosis support apparatus 10 is composed of a CPU (Central Processing Unit) 11, I/F (InterFace) 12, operation section 13, display section 14, communication section 15, RAM (Random Access Memory) 16, ROM (Read Only Memory) 17, printer 18, etc. and each section is connected to each other through a bus 19.

The CPU 11 reads out a system program and various processing programs stored in the ROM 17 and develops them to the RAM 16, and in conjunction with the expanded program, the CPU 11 performs various processing such as a later described left and right breast mapping processing and centrally controls operation of each section of the image diagnosis support apparatus 10.

The I/F 12 is an interface for connection to an image generation apparatus G and the image data generated in the image generation apparatus G is input to the image diagnosis support apparatus 10.

The image generation apparatus G is an apparatus to image breasts of a patient as an object and then to digitally convert the imaged image to generate breast image data. For example, a CR (Computed Radiography) apparatus, FPD (Flat Panel Detector) apparatus, etc. can be applied as the image generation apparatus G.

In the present embodiment, the image generation apparatus G generates a pair of left and right breast image data (left breast image data L and right breast image data R) for each patient and inputs the data to the image diagnosis support apparatus 10.

The operation section 13 is composed of a keyboard including cursor keys, numeral keys and various function keys and an operation signal corresponding to the pressed key is output to the CPU 11. A pointing device such as a mouse, touch panel, etc. can be included as necessary.

The display section 14 is composed of a monitor such as an LCD, CRT, etc. and according to an instruction of a display signal input from the CPU 11, performs display of a breast image, etc.

The communication section 15 is composed of a communication interface such as a network interface card, modem, terminal adapter, etc., and performs sending and receiving of various information to and from external devices on the communication network. For example, a configuration where image data is received from the image generation apparatus G through the communication section 15 or a configuration connected to an image server, etc. of a hospital through the communication section 15 is possible.

The RAM 16 forms a work area where various programs performed by the CPU 11 or pieces of data processed by these programs are temporarily stored.

The ROM 17 stores various programs performed by the CPU 11 or data such as parameters necessary to perform processing by the programs, processing results, etc. Such various programs are stored in a form of readable program code, and the CPU 11 sequentially performs operation according to the program code.

The printer 18 forms an image on a recording medium such as a film, etc. based on the image data according to control by the CPU 11 and outputs the image.

### (Operation of the Image Diagnosis Support Apparatus 10)

Next, the operation of the first embodiment will be described.

In the image diagnosis support apparatus 10, when the left breast image data L (hereinafter referred to as breast image data L) and the right breast image data R (hereinafter referred to as breast image data R) are input from the image generation apparatus G, left and right breast mapping processing described below is performed, and the diagnostic corresponding positions including the same tissue are made to be corresponded on the left and right breast images. The pixel value of the breast image data L and R is a value which shows density.

### (Left and Right Breast Mapping Processing)

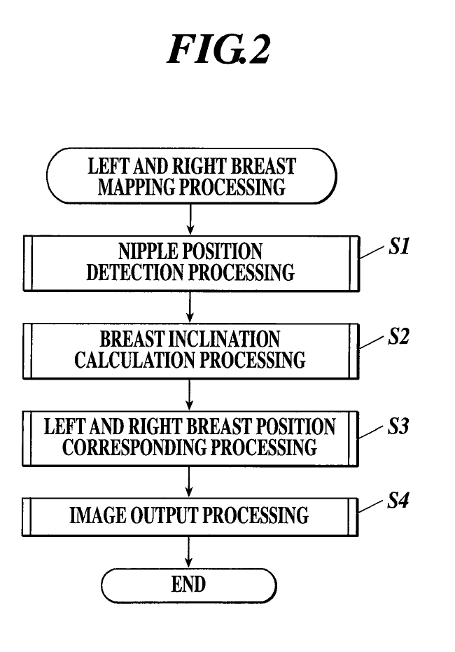

FIG. 2 is a flow showing the left and right breast mapping processing performed in the image diagnosis support apparatus 10. The processing is realized by software processing performed by the CPU 11 in conjunction with a left and right breast mapping processing program stored in the ROM 17.

First, the input left and right breast image data L and breast image data R are input and nipple position detection processing is performed to detect a position of the nipple (nipple coordinate) in the breast image data L and a position of the nipple (nipple coordinate) in the breast image data R (step S1).

Next, breast inclination calculation processing is performed and the positions of the nipples detected in step S1 are used to calculate a straight line showing an inclination of the breast in the breast image data L and a straight line showing an inclination of the breast in the breast image data R (step S2).

Next, left and right breast position corresponding processing is performed and sets a polar coordinate system with its origin at the position of the nipple detected in step S1 and its axis on the straight line showing the inclination of the breast calculated in step S2 in each of the breast image data L and the breast image data R and makes the positions in the breast image data L and the breast image data R correspond to each other in the polar coordinate systems (step S3).

Then, image output processing is performed and the left and right breast images are displayed side-by-side on the display section 14 based on the breast image data L and the breast image data R and a scale showing an angle from the axis of the polar coordinate system and a distance from the origin of the polar coordinate system is superimposed to be displayed on each of the displayed breast images (step S4) and the processing ends.

Below, the processing performed in step S1 to S4 will be descried in detail.

As for the nipple position detection processing and the breast inclination processing, the same processing is performed on the breast image data L and the breast image data R, and thus the processing performed on the breast image data L will be described as an example.

### (Nipple Position Detection Processing)

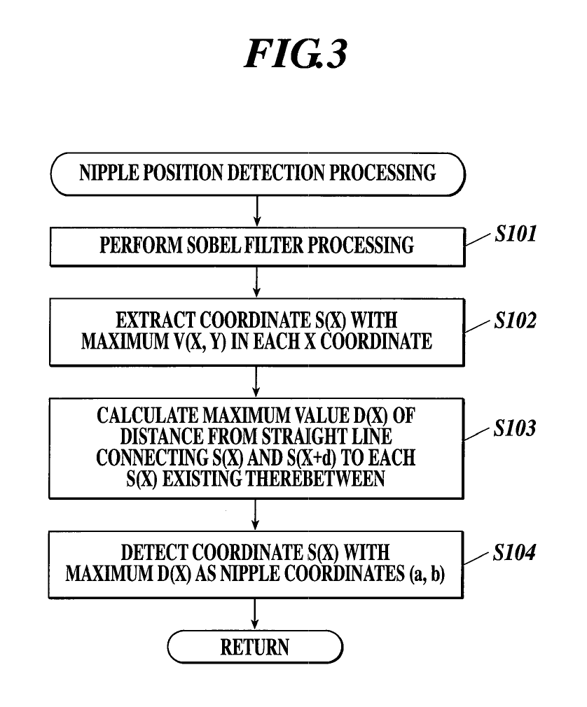

FIG. 3 shows a flow of the nipple position detection processing performed in step S1 shown in FIG. 2. The processing is realized by a software processing performed by the CPU 11 in conjunction with a nipple position detection processing program stored in the ROM 17.

First, filtering processing by Sobel filter is performed on each pixel of the breast image data L as a target pixel and the breast image data L after filter processing (hereinafter referred to as breast image data L1) is obtained (step S101). Each pixel value of the breast image data L1 shows edge intensity.

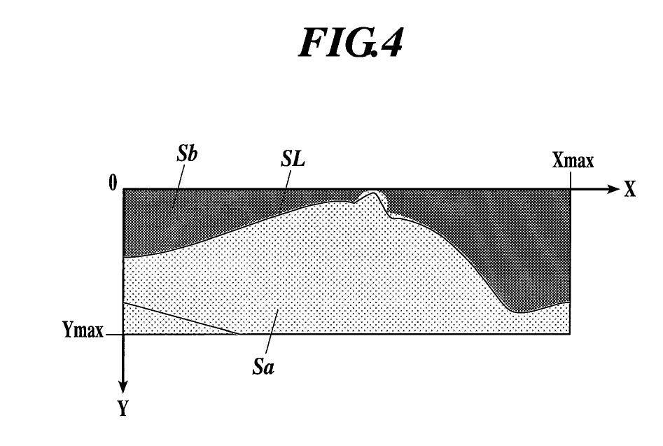

Below, as shown in FIG. 4, the position of each pixel in breast image data L1 is represented by a coordinate (X, Y) where a direction from top to bottom of the breast is shown with an X axis and a direction perpendicular to this direction is shown with a Y axis in the breast image data L1. Also, the pixel value of the coordinates (X, Y) in the breast image data L1 is represented by V(X, Y). Also, the coordinate of the edge of the image in the X axis direction is represented by Xmax and the edge of the image in the Y axis direction is represented by Ymax.

Next, a search is performed on each X coordinate (0 to Xmax) of the breast image data L1 in the Y axis direction and the coordinate S(X) with the maximum V(X, Y) is extracted (step S102). With this, the edge on each X coordinate of the breast image data L1 is extracted. As shown in FIG. 4, the extracted edge is the boundary point between the breast area Sa and the non-breast area Sb (background) in the breast image data L1 and composes the skin line SL.

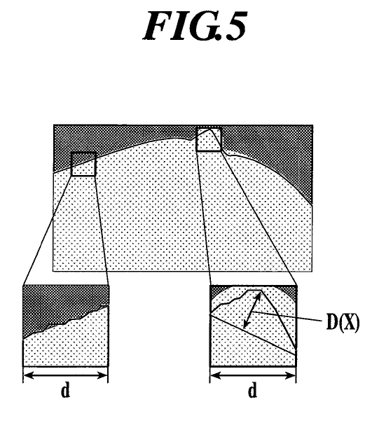

Next, as shown in FIG. 5, as for each S(X) extracted in step S102, distances D between a straight line connecting S(X) and S(X+d(d is for example 10)) and each point from S(X) to S(X+d) are calculated and the maximum value D(X) is calculated from the calculated distances D (step S103).

After D(X) for each S(X) is calculated, the S(X) with the largest value among the calculated D(X) is detected as the nipple coordinates (a, b) representing the nipple position (step S104) and the processing ends.

The same processing as the above described nipple position detection processing is performed on the breast image data R and the nipple coordinates (a, b) are detected.

### (Breast Inclination Calculation Processing)

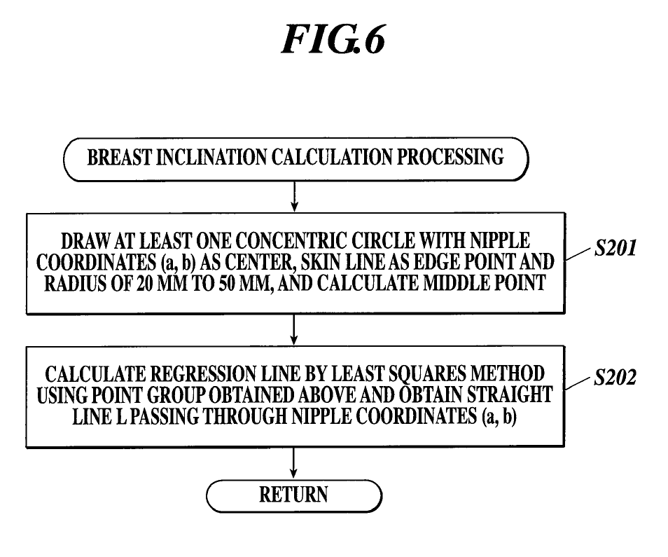

FIG. 6 shows a flow of breast inclination calculation processing performed in step S2 shown in FIG. 2. The processing is realized by software processing performed by the CPU 11 in conjunction with a breast inclination calculation processing program stored in the ROM 17.

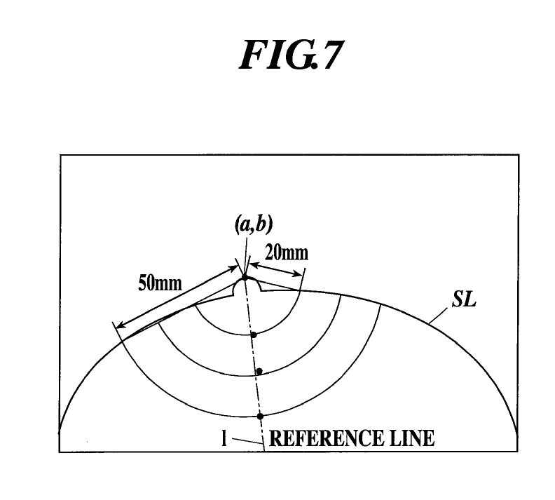

In the breast inclination calculation processing, first, in the breast image data L, at least two concentric circles are drawn with a center at the nipple coordinates (a, b) detected in the above described nipple position detection processing and a radius of 20 mm to 50 mm where the edge point is on the skin line SL as schematically shown in FIG. 7 and the middle point is calculated (step S201). In order to enhance the accuracy of processing, a plurality of concentric circles of two or more can be drawn and a plurality of points can be calculated.

Next, using the point group calculated in step S201, a regression line is calculated by the least squares method to obtain the straight line l showing the inclination of the breast passing through the nipple coordinates (a, b) (step S202) and the processing ends. The following formula 1 is used as the calculation formula of the regression line l by the least squares method.

$$a = \frac{{\sum }_{i = 1}^{n} ( {X}_{i} - \overline{X} ) ( {Y}_{i} - \overline{Y} )}{{\sum }_{i = 1}^{n} {( {X}_{i} - \overline{X} )}^{2}} \\ b = \overline{Y} - a \overline{X} \qquad [ Formula 1 ]$$

a: INCLINATION OF REGRESSION LINE
b: INTERCEPT OF REGRESSION LINE
X̅: AVERAGE VALUE OF X COORDINATE OF POINT GROUP
Y̅: AVERAGE VALUE OF Y COORDINATE OF POINT GROUP

The same processing as the above described breast inclination calculation processing is performed on the breast image data R and the straight line l showing the inclination of the breast is obtained.

### (Left and Right Breast Position Corresponding Processing)

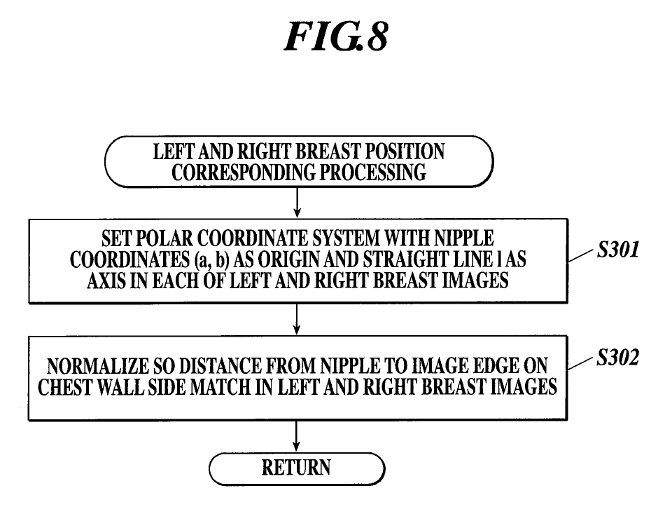

FIG. 8 shows a flow of the left and right breast position corresponding processing performed in step S3 shown in FIG. 2. The processing is realized by a software processing performed by the CPU 11 in conjunction with a left and right breast position corresponding processing program stored in the ROM 17.

First, a polar coordinate system is set with its origin at the nipple coordinates (a, b) detected in the nipple position detection processing and its axis on the straight line l showing the inclination of the breasts obtained in the breast inclination calculation processing in each of the breast image data L and the breast image data R and makes the positions in the breast image data L and the breast image data R correspond to each other in the polar coordinate system (step S301). In other words, the positions where the distance from the nipple coordinates (a, b) and the angle from the axis l match on the set polar coordinate system in the breast image data L and the breast image data R are made to correspond.

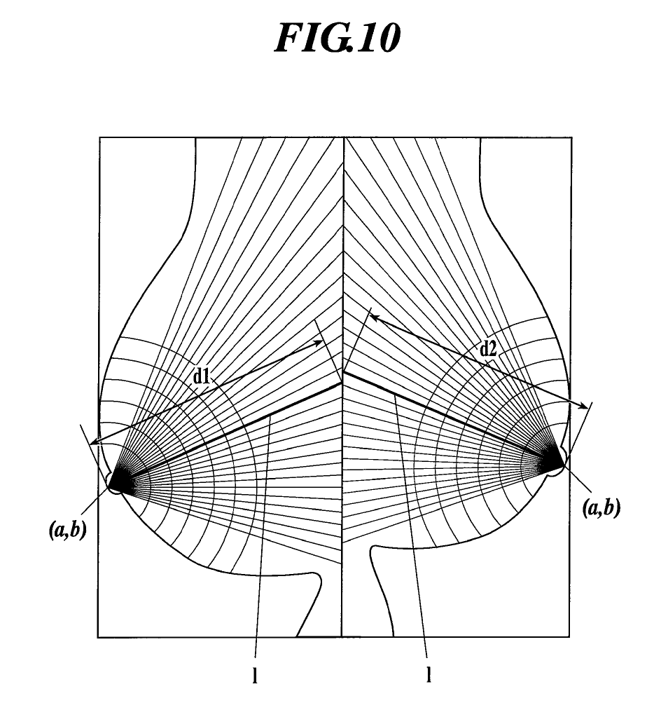

Next, the distance d1 (see FIG. 10) on the axis l from the nipple to the edge of the image on the chest wall side in the breast image data R is calculated and the distance d2 (see FIG. 10) on the axis l from the nipple to the edge of the image on the chest wall side in the breast image data L is calculated and normalization of d1 and d2 so that either one of the lengths matches the other is performed (step S302).

As described above, by setting the polar coordinate system with its origin at the nipple coordinates (a, b) and its axis on a straight line l in the breast image data L and breast image data R and making the positions in the breast image data L and the breast image data R correspond to each other in the polar coordinate system, the diagnostic corresponding positions in the left and right breast images can be specified.

### (Image Output Processing)

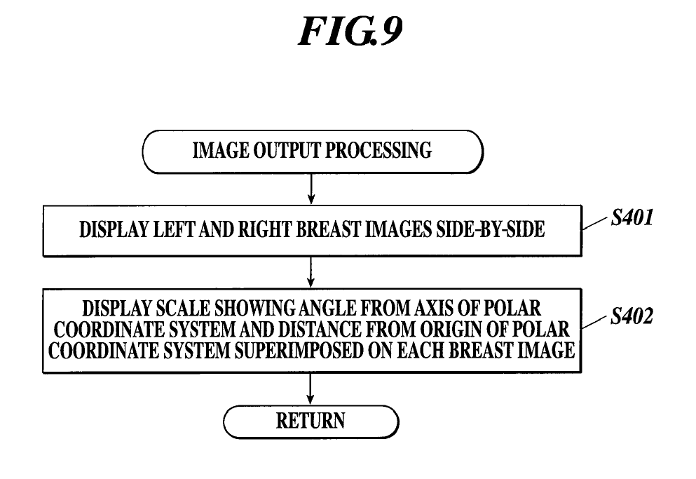

FIG. 9 is a flow showing image output processing performed in step S4 shown in FIG. 2. The processing is realized by software processing by the CPU 11 in conjunction with an image output processing program stored in the ROM 17.

In the image output processing, based on the breast image data L and the breast image data R, the left and right breast images are displayed on the display section 14 side-by-side in the same vertical direction (step S401), and a scale showing the angle from the axis l and the distance from the origin in the polar coordinate system is superimposed and displayed on each of the displayed left and right breast images.

FIG. 10 schematically shows an example of left and right breast images displayed on the display section 14 in step S402 shown in FIG. 9. As shown in FIG. 10, in the image diagnosis support apparatus 10, a scale showing the angle from the axis and the distance from the nipple in the polar coordinate system is added and displayed on each of the pair of left and right breast images. With this, a doctor can easily recognize diagnostic corresponding positions on the displayed left and right breast images and accuracy of the comparison interpretation can be enhanced. Also, the diagnostic efficiency can be enhanced.

Although a pitch of the displayed scale is determined in advance, the pitch can be changed according to input from the operation section 13. Fine adjustment of the pitch allows the doctor to recognize the corresponding positions on the left and right breast images more accurately.

As described above, according to an image diagnosis support apparatus 10 of the present invention, the image diagnosis support apparatus 10 detects positions of nipples from each of a pair of left and right breast images, calculates a straight line l to show inclinations of the breasts based on the position of the detected nipples, sets up a polar coordinate system with its origin at the position of the nipple and its axis on the straight line l to show the inclination of the breast in each of the left and right breast images and makes the positions in the left and right breast images correspond to each other in the polar coordinate systems. Therefore, the diagnostic corresponding positions in the left and right breast images can be accurately identified without the influence of error caused by deformation due to compression of the breasts when the left and right breast images are imaged. Also, the diagnostic corresponding positions in the left and right breast images can be identified without changing the processing according to a condition at the time of imaging such as imaging direction.

Also, when the left and right breast images are displayed, a scale showing the angle from the axis and the distance from the nipple in the origin is added and displayed, and consequently the doctor can easily recognize the diagnostic corresponding positions in the left and right breasts and the accuracy of the comparison interpretation can be enhanced. Also, diagnostic efficiency can also be enhanced.

In the above described embodiment, an example where a scale showing the angle from the axis and the distance from the nipple in the polar coordinate system is added to the left and right breast images and displayed on the display section 14 by the image output processing is described, however, the output method of the image is not limited to the above. For example, an image with a scale showing the angle from the axis and the distance from the nipple in the polar coordinate system added to the left and right breast images can be formed on a recording medium such as a film and be output by the printer 18.

### Second Embodiment

Below, the second embodiment of the present invention will be described. The configuration of the image diagnosis support apparatus 10 of the second embodiment is the same as explained in the first embodiment and thus the explanation is omitted. Also, the operation of the second embodiment is the same as explained in the first embodiment from the nipple position detection processing to the left and right breast position corresponding processing and thus the explanation is omitted, and below, the annotation display processing performed after the left and right breast position corresponding processing according to the present embodiment will be described.

### (Annotation Display Processing)

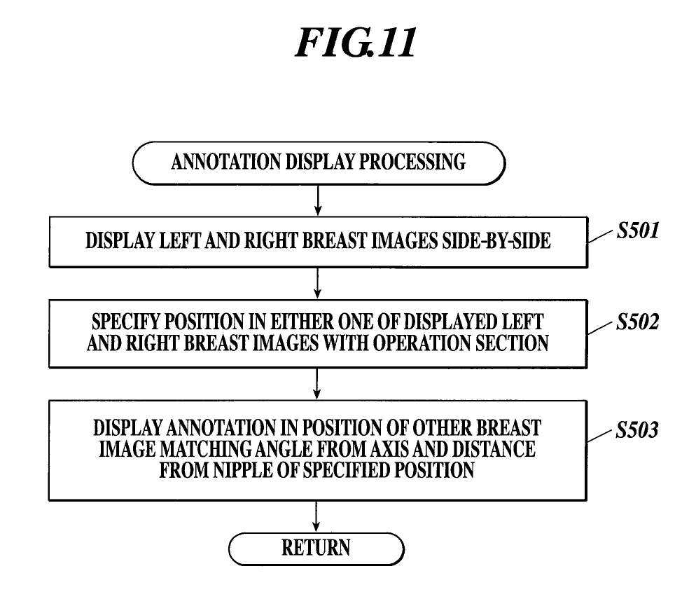

FIG. 11 shows a flow of the annotation display processing. The processing is realized by software processing performed by the CPU 11 in conjunction with an annotation display processing program stored in the ROM 17.

First, based on the breast image data L and the breast image data R, the left and right breast image are displayed on the display section 14 side-by-side in the same vertical direction (step S501).

When a desired position in either one of the left and right breast images displayed on the display section 14 is specified with a mouse, etc. of the operation section 13 (step S502), an annotation is superimposed and displayed at a position on the other breast image in which the angle from the axis l and the distance from the nipple at the origin matches the position specified with the operation section 13 (step S503).

As described above, according to the second embodiment, when a desired position in either one of the left and right breast images displayed on the display section 14 is specified with the operation section 13, an annotation is displayed in a position on the other breast image in which the angle from the axis and the distance from the nipple matches those of the specified position, and consequently the doctor can easily recognize the diagnostic corresponding positions in the left and right breasts and the accuracy of the comparison interpretation can be enhanced. Also, the diagnostic efficiency can also be enhanced.

The descriptions of the above described embodiments are suitable examples of the image diagnosis support apparatus 10 of the present embodiment and the present invention is not limited to these examples.

Also, the specific configuration and the specific operation of the image diagnosis support apparatus 10 can be modified within the scope of the present invention.

The entire contents including specification, claims, drawings and abstract of Japanese Patent Application No. 2007-257652 filed on Oct. 1, 2007 to the Japanese Patent Office are incorporated herein by reference.

### INDUSTRIAL APPLICABILITY

The present invention can be used in the field of medicine to support comparison interpretation of left and right breast images by a doctor.

### DESCRIPTION OF REFERENCE NUMERALS

10 image diagnosis support apparatus
11 CPU
12 I/F
13 operation section
14 display section
15 communication section
16 RAM
17 ROM
18 printer
19 bus

1. An image diagnosis support apparatus comprising:
a nipple position detection section to detect a position of a nipple from each of a pair of left and right breast images;
a breast inclination calculation section to calculate a straight line to show inclination of a breast based on the position of the nipple detected from each of the left and right breast images; and
a left and right breast position corresponding section to set a polar coordinate system with an origin at the detected position of the nipple and an axis on the straight line which shows the calculated inclination of the breast in each of the left and right breast images and to make positions in the left and right breast images correspond to each other in the polar coordinate systems.

2. The image diagnosis support apparatus of claim 1, further comprising an image output section to perform output by adding a scale to show an angle from the axis and a distance from the origin in each of the left and right breast images.

3. The image diagnosis support apparatus of claim 1, further comprising:
a display section to display the left and right breast images;
an operation section to specify a desired position in either one of the left and right breast images displayed on the display section; and
an annotation display section to display an annotation in a position in the other breast image in which an angle from the axis and a distance from the origin matches those of the position specified with the operation section in the one of the breast images.

4. A method to make positions correspond in left and right breast images, the method comprising:
detecting a position of a nipple from each of a pair of left and right breast images;
calculating a straight line to show inclination of a breast based on the position of the nipple detected from each of the left and right breast images; and
setting a polar coordinate system with an origin at the detected position of the nipple and an axis on the straight line which shows the calculated inclination of the breast in each of the left and right breast images and making positions in the left and right breast images correspond to each other in the polar coordinate systems.

5. The method to make positions correspond in left and right breast images of claim 4, the method further comprising performing output by adding a scale to show an angle from the axis and a distance from the origin in each of the left and right breast images.

6. The method to make positions correspond in left and right breast images of claim 4, the method further comprising:
displaying the left and right breast images;
specifying with an operation section a desired position in either one of the left and right breast images displayed on the display section; and
displaying an annotation in a position in the other breast image in which an angle from the axis and a distance from the origin matches those of the position specified in the one of the breast images.

7. A computer readable medium embodying a program to allow a computer to function as:
a nipple position detection section to detect a position of a nipple from each of a pair of left and right breast images;
a breast inclination calculation section to calculate a straight line to show inclination of a breast based on the position of the nipple detected from each of the left and right breast images; and
a left and right breast position corresponding section to set a polar coordinate system with an origin at the detected position of the nipple and an axis on the straight line which shows the calculated inclination of the breast in each of the left and right breast images and to make positions in the left and right breast images correspond to each other in the polar coordinate systems.

8. The computer readable medium of claim 7 embodying a program to allow a computer to further function as an image output section to perform output by adding a scale to show an angle from the axis and a distance from the origin in each of the left and right breast images.

9. The computer readable medium of claim 7 embodying a program to allow a computer to further function as:
a display section to display the left and right breast images;
an operation section to specify a desired position in either one of the left and right breast images displayed on the display section; and
an annotation display section to display an annotation in a position in the other breast image in which an angle from the axis and a distance from the origin matches those of the position specified with the operation section in the one of the breast images.
